(19) United States
(12) Patent Application Publication
(10) Pub. No.: US 2025/0370628 A1
(43) Pub. Date: Dec. 4, 2025

(54) MEMORY DEVICE, SYSTEM-ON-CHIP CONFIGURED TO CONTROL MEMORY DEVICE, AND ELECTRONIC DEVICE INCLUDING THE SAME

(71) Applicant: Samsung Electronics Co., Ltd., Suwon-si (KR)

(72) Inventors: Donghee Kim, Suwon-si (KR); Youngsan Kang, Suwon-si (KR); Changyong Lee, Suwon-si (KR); Jieun Kim, Suwon-si (KR); Unho Lee, Suwon-si (KR); Sungoh Huh, Suwon-si (KR)

(21) Appl. No.: 19/001,725

(22) Filed: Dec. 26, 2024

(30) Foreign Application Priority Data
Jun. 4, 2024 (KR) 10-2024-0072966

(51) Int. Cl. G06F 3/06

(52) U.S. Cl. CPC G06F 3/0614; G06F 3/0634; G06F 3/0653; G06F 3/0673

(57) ABSTRACT

Disclosed is an electronic device that includes a memory device operating in a current frequency set point (FSP) operation mode among FSP operation modes and a system-on-chip (SoC) controlling the memory device. The memory device includes FSP mode register sets storing FSP data sets respectively corresponding to the FSP operation modes, and a temperature monitoring circuit monitoring a temperature range of the memory device. The SoC controls the current FSP operation mode based on a current operation frequency of the memory device and a current temperature range of the memory device. The FSP operation modes include a first FSP operation mode for an operation of the memory device at a first operation frequency and a first temperature range, and a second FSP operation mode for an operation of the memory device at the first operation frequency and a second temperature range higher than the first temperature range.

### CROSS-REFERENCE TO RELATED APPLICATIONS

This application claims priority under 35 U.S.C. § 119 to Korean Patent Application No. 10-2024-0072966 filed on Jun. 4, 2024, in the Korean Intellectual Property Office, the disclosure of which is incorporated by reference herein in its entirety.

### BACKGROUND OF THE INVENTION

Embodiments of the present disclosure described herein relate to a semiconductor memory, and more particularly, relate to a memory device, a system-on-chip configured to control the memory device, and an electronic device including the same.

A semiconductor memory can be classified as a volatile memory, which loses data stored therein when a power is turned off, such as a static random access memory (SRAM) or a dynamic random access memory (DRAM), or a nonvolatile memory, which retains data stored therein even when a power is turned off, such as a flash memory, a phase-change RAM (PRAM), a magnetic RAM (MRAM), a resistive RAM (RRAM), or a ferroelectric RAM (FRAM).

The DRAM is being widely used as a system memory of a mobile device or a computer device. Also, the DRAM may be used as a system memory of an electronic device which operates in an automotive environment. The DRAM which is used in the automotive environment may operate in more extreme conditions than are typical. Accordingly, a DRAM with a wide operating temperature range is being developed.

### SUMMARY OF THE INVENTION

Embodiments of the present disclosure provide a memory device with improved reliability and improved performance, a system-on-chip configured to control the memory device, and an electronic device including the same.

According to aspects of the present disclosure, an electronic device includes a memory device configured to operate in a current frequency set point (FSP) operation mode among a plurality of FSP operation modes, and a system-on-chip (SoC) configured to control the memory device. The memory device includes FSP mode register sets configured to store a plurality of FSP data sets respectively corresponding to the plurality of FSP operation modes, and a temperature monitoring circuit configured to monitor a temperature range of the memory device. The SoC is further configured to control the current FSP operation mode based on a current operation frequency of the memory device and a current temperature range of the memory device. The plurality of FSP operation modes include a first FSP operation mode for an operation of the memory device at a first operation frequency and a first temperature range, and a second FSP operation mode for an operation of the memory device at the first operation frequency and a second temperature range higher than the first temperature range.

According to aspects of the present disclosure, an operating method of a system-on-chip (SoC) configured to control a memory device operating based on a current frequency set point (FSP) operation mode among a plurality of FSP operation modes includes training the memory device for a plurality of operation frequencies and a plurality of temperature ranges, based on a training code, storing a plurality of FSP data sets, which are obtained through the training and respectively correspond to the plurality of FSP operation modes, in the memory device, and controlling the current FSP operation mode based on a current operation frequency or a current temperature range of the memory device. The plurality of FSP operation modes include a first FSP operation mode for an operation of the memory device at a first operation frequency among the plurality of operation frequencies and a first temperature range among the plurality of temperature ranges, and a second FSP operation mode for an operation of the memory device at the first operation frequency and a second temperature range higher than the first temperature range among the plurality of temperature ranges.

According to aspects of the present disclosure, a memory device that is configured to operate based on a current frequency set point (FSP) operation mode among a plurality of FSP operation modes includes an FSP selection mode register configured to store information about the current FSP operation mode, FSP mode register sets configured to store FSP data sets respectively corresponding to the plurality of FSP operation modes, a temperature monitoring mode register configured to store temperature data associated with a current temperature range of the memory device, a temperature monitoring circuit configured to monitor the current temperature range, and a control logic circuit configured to control operating parameters of the memory device based on an FSP data set corresponding to the current FSP operation mode from among the FSP data sets. The plurality of FSP operation modes include a first FSP operation mode for an operation of the memory device in a first temperature range, and a second FSP operation mode for an operation of the memory device in a second temperature range higher than the first temperature range. The current FSP operation mode is determined based on the temperature data.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating an electronic device according to embodiments of the present disclosure.

FIG. 2 is a block diagram illustrating a system-on-chip (SoC) of FIG. 1.

FIG. 3 is a block diagram illustrating a memory device of FIG. 1.

FIG. 4 is a flowchart for describing an operating method of an SoC of FIG. 1.

FIGS. 5A and 5B are diagrams for describing a training operation of FIG. 4 in detail.

FIG. 6 is a diagram for describing FSP mode register sets of FIG. 1.

FIG. 7 is a diagram for describing a frequency set point (FSP) selection mode register of FIG. 1.

FIG. 8 is a flowchart for describing an operation of controlling a current FSP operation mode, which is described with reference to FIG. 4.

FIG. 9 is a flowchart for describing an operation of determining whether to change a current FSP operation mode, which is described with reference to FIG. 8.

FIG. 10 is a diagram for describing a temperature monitoring mode register of FIG. 1.

FIG. 11 is a diagram for describing an operation of an electronic device of FIG. 1 in detail.

FIG. 12 is a diagram for describing an operating method of a memory device of FIG. 1.

FIG. 13 is a diagram for describing an example of an operation of an electronic device of FIG. 1.

FIG. 14 is a diagram for describing a temperature monitoring circuit of FIG. 1.

FIG. 15 is a diagram for describing another example of an electronic device according to embodiments of the present disclosure.

### DETAILED DESCRIPTION

Below, embodiments of the present disclosure will be described in detail and clearly to such an extent that one of ordinary skill in the art can easily carry out the present disclosure.

In the specification, function blocks of drawings, which respectively correspond to the terms “block”, “unit”, “logic”, etc., may be implemented in the form of software, hardware, or a combination thereof.

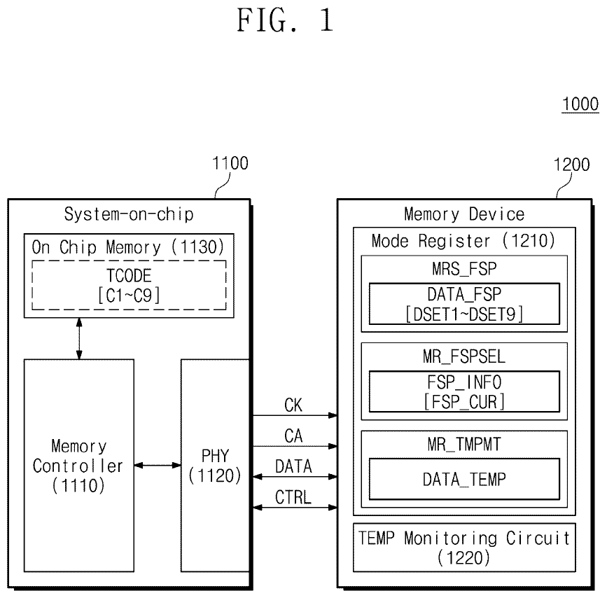

FIG. 1 is a block diagram illustrating an electronic device according to embodiments of the present disclosure. Referring to FIG. 1, an electronic device 1000 may include a system-on-chip 1100 and a memory device 1200. In some embodiments, the electronic device 1000 may be one of information processing devices, which are configured to process a variety of information and to store the processed information, such as a personal computer (PC), a laptop, a server, a workstation, a smartphone, a tablet PC, a digital camera, and a black box. In some embodiments, the electronic device 1000 may be included in an automotive device.

The system-on-chip (SoC) 1100 may control all the operations of the electronic device 1000. For example, the SoC 1100 may be an application processor (AP) configured to control all the operations of the electronic device 1000. The SoC 1100 may run an operating system, a program, or an application that is executable in the electronic device 1000. In some embodiments, the SoC 1100 may include intellectual property (IP) blocks for controlling various operations of the electronic device 1000 or for controlling various components included in the electronic device 1000.

The SoC 1100 may store data in the memory device 1200 or may read data stored in the memory device 1200. The SoC 1100 may include a memory controller 1110, a physical layer (PHY) 1120, and an on chip memory 1130. The memory controller 1110 may be configured to control the memory device 1200 through the PHY 1120.

Under control of the memory controller 1110, the PHY 1120 may transmit a clock signal CK and a command/address signal CA to the memory device 1200 and may exchange data “DATA” with the memory device 1200. In some embodiments, the PHY 1120 may exchange the data “DATA” with the memory device 1200 by using a data signal DQ and a data strobe signal DQS. The PHY 1120 may exchange a control signal CTRL with the memory device 1200. In some embodiments, the PHY 1120 may be a DDR-PHY configured to support the DDR interface. That is, the PHY 1120 may be configured to support various standard interfaces, which are defined by the JEDEC standard, such as a double data rate (DDR), a graphic DDR (GDDR), and a low-power DDR (LPDDR).

The on chip memory 1130 may include various components, which are used by the electronic device 1000 to operate, such as an application program, an operating system, a file system, and a device driver. In some embodiments, the on chip memory 1130 may include a training code TCODE. The training code TCODE may be used in the training for the memory device 1200. The training code TCODE may refer to a code associated with operation options for each temperature range and operation frequency (i.e., for each operating environment) of the memory device 1200.

The memory device 1200 may operate under control of the SoC 1100. In some embodiments, the memory device 1200 may be a dynamic random access memory (DRAM) device. However, the present disclosure is not limited thereto. For example, the memory device 1200 may include a volatile memory such as a static RAM (SRAM) or a nonvolatile memory such as a flash memory, a phase-change RAM (PRAM), or a resistive RAM (RRAM).

The memory device 1200 may operate based on a current frequency set point (FSP) operation mode FSP_CUR among a plurality of FSP operation modes. In some embodiments, the memory device 1200 may control setting values of operating parameters based on the current FSP operation mode FSP_CUR. In some embodiments, the operating parameters may include a write latency, a read latency, a command/address (CA) reference voltage, a DQ reference voltage, whether to activate a specific function (e.g., an on die termination (ODT) function) of the memory device 1200, and whether to activate a specific circuit of the memory device 1200.

In some embodiments, the plurality of FSP operation modes may include a first FSP operation mode to a ninth FSP operation mode. The first to ninth FSP operation modes may correspond to first to ninth operating environments of the memory device 1200. In some embodiments, the memory device 1200 may operate in the first operating environment. In this case, the SoC 1100 may set the current FSP operation mode FSP_CUR of the memory device 1200 to the first FSP operation mode. That is, the current FSP operation mode FSP_CUR of the memory device 1200 may be determined based on a current operating environment of the memory device 1200.

In some embodiments, the first operating environment may correspond to a low operation frequency and a high temperature range; the second operating environment may correspond to the low operation frequency and a middle temperature range; the third operating environment may correspond to the low operation frequency and a low temperature range; the fourth operating environment may correspond to a middle operation frequency and the high temperature range; the fifth operating environment may correspond to the middle operation frequency and the middle temperature range; the sixth operating environment may correspond to the middle operation frequency and the low temperature range; the seventh operating environment may correspond to the high operation frequency and the high temperature range; the eighth operating environment may correspond to the high operation frequency and the middle temperature range; and the ninth operating environment may correspond to the high operation frequency and the low temperature range. Meanwhile, the “temperature range” may mean a range to which an internal temperature of the memory device 1200 belongs when the memory device 1200 operates.

In some embodiments, the high temperature range may indicate a temperature range of +50° C. or higher to +125° C. or lower (i.e., from +50° C. to +125° C.), the middle temperature range may indicate a temperature range of +10° C. or higher to +50° C. or lower (i.e., from +10° C. to +50° C.), and the low temperature range may indicate a temperature range of −40° C. or higher to +10° C. or lower (i.e., from −40° C. to +10° C.). However, the present disclosure is not limited thereto.

The memory device 1200 may include a mode register 1210 and a temperature monitoring circuit 1220. The mode register 1210 may be configured to store or manage a variety of information used by the memory device 1200 to operate. The mode register 1210 may include an FSP mode register sets MRS_FSP, an FSP selection mode register MR_FSPSEL, and a temperature monitoring mode register MR_TMPMT.

The FSP mode register sets MRS_FSP may store FSP data DATA_FSP. The FSP data DATA_FSP may be obtained by the training for the memory device 1200 of the SoC 1100. The FSP data DATA_FSP may include first to ninth FSP data sets DSET1 to DSET9 corresponding to the first to ninth FSP operation modes. Each of the first to ninth FSP data sets DSET1 to DSET9 may include information about operating parameters of the memory device 1200, in the corresponding FSP operation mode.

The FSP selection mode register MR_FSPSEL may store FSP information FSP_INFO including information about the current FSP operation mode FSP_CUR of the memory device 1200. In some embodiments, the memory device 1200 may operate based on an FSP data set corresponding to the current FSP operation mode FSP_CUR. For example, the current FSP information FSP_INFO may indicate that the current FSP operation mode FSP_CUR is the first FSP operation mode. Meanwhile, the first FSP operation mode may correspond to the first FSP data set DSET1. In this case, the memory device 1200 may determine setting values of operating parameters of the memory device 1200 based on the first FSP data set DSET1.

In some embodiments, the SoC 1100 may change a setting value of the FSP information FSP_INFO to change the current FSP operation mode FSP_CUR of the memory device 1200. For example, the SoC 1100 may change a setting value of the FSP selection mode register MR_FSPSEL in response to at least one of the current operation frequency or the current temperature range of the memory device 1200 being changed. In this case, the memory device 1200 may change the setting values of the operating parameters based on an FSP operating data set corresponding to the current FSP operation mode FSP_CUR.

The temperature monitoring mode register MR_TMPMT may store temperature data DATA_TEMP. The temperature data DATA_TEMP may include information about a current temperature range of the memory device 1200. The SoC 1100 may determine the current FSP operation mode FSP_CUR based on the temperature data DATA_TEMP.

The temperature monitoring circuit 1220 may monitor a current temperature of the memory device 1200. The temperature monitoring circuit 1220 may determine whether the temperature range of the memory device 1200 is changed, based on the current temperature. For example, the temperature monitoring circuit 1220 may monitor the temperature range of the memory device 1200. The memory device 1200 may adjust the temperature data DATA_TEMP, based on a monitoring result of the temperature monitoring circuit 1220.

Meanwhile, the SoC 1100 may train the memory device 1200 based on the training code TCODE (e.g., upon booting of memory device 1200, or before booting of memory device 1200). In the training, the SoC 1100 may control the memory device 1200 based on the training code TCODE. For example, the memory device 1200 may be controlled based on the training code TCODE as if operating in a specific operating environment (e.g., at a specific operation frequency and in a specific temperature range). The SoC 1100 may obtain the FSP data DATA_FSP through the training and may store the FSP data DATA_FSP in the FSP mode register sets MRS_FSP. Meanwhile, the FSP data DATA_FSP may include the first to ninth FSP data sets DSET1 to DSET9

The training code TCODE may include a first code C1 to a ninth code C9. The first to ninth codes C1 to C9 may correspond to the first to ninth operating environments described above. In detail, the first code C1 may be a code corresponding to the first operating environment; the second code C2 may be a code corresponding to the second operating environment; the third code C3 may be a code corresponding to the third operating environment; the fourth code C4 may be a code corresponding to the fourth operating environment; the fifth code C5 may be a code corresponding to the fifth operating environment; the sixth code C6 may be a code corresponding to the sixth operating environment; the seventh code C7 may be a code corresponding to the seventh operating environment; the eighth code C8 may be a code corresponding to the eighth operating environment; and, the ninth code C9 may be a code corresponding to the ninth operating environment.

The SoC 1100 may train the memory device 1200 based on the first code C1. In this case, in the training, the memory device 1200 may operate as if operating in the first operating environment (e.g., of the low operation frequency and the high temperature range). Accordingly, as a result of the training based on the first code C1, the SoC 1100 may obtain the first FSP data set DSET1 optimized for the memory device 1200 which operates in the first operating environment (i.e., in which the current FSP operation mode FSP_CUR is the first FSP operation mode). In some embodiments, the first FSP data set DSET1 may include information about operating parameters which allow the memory device 1200 to operate with the maximum operating margin in the first operating environment.

As in the above description (e.g. similar to obtaining the first FSP data set DSET1), the SoC 1100 may train the memory device 1200 based on the second to ninth codes C2 to C9. Accordingly, the SoC 1100 may obtain the second to ninth FSP data sets DSET2 to DSET9. Each of the second to ninth FSP data sets DSET2 to DSET9 may include information about operating parameters for the optimal operation of the memory device 1200 in the corresponding environment (i.e., of the corresponding operation frequency and the corresponding temperature range). In other words, the SoC 1100 may obtain information about operating parameters for the optimal operation of the memory device 1200 for each operating environment through the training.

Meanwhile, the SoC 1100 may check a current operation frequency of the memory device 1200. Also, the SoC 1100 may check a current temperature range of the memory device 1200 based on the temperature data DATA_TEMP. The SoC 1100 may determine the current FSP operation mode FSP_CUR of the memory device 1200, based on the current temperature range and the current operation frequency (i.e., the current operating environment). That is, the SoC 1100 may determine the current operating environment of the memory device 1200 and may set an FSP operation mode corresponding to the current operating environment as the current FSP operation mode FSP_CUR. Meanwhile, the operating parameters of the memory device 1200 may be determined based on an FSP data set corresponding to the current FSP operation mode FSP_CUR. Accordingly, the memory device 1200 may operate based on the operating parameters optimized for the current operating environment.

For example, the memory device 1200 may be operating in the first operating environment (i.e., of the low operation frequency and the high temperature range). In this case, the current temperature of the memory device 1200 may sharply decrease. Accordingly, the current operating environment of the memory device 1200 may be changed to the third operating environment (i.e., a current operation frequency and a current temperature range of the memory device 1200 may be changed to the low operation frequency and the low temperature range). In this case, the SoC 1100 may change the current FSP operation mode FSP_CUR from the first FSP operation mode to the third FSP operation mode. Accordingly, the memory device 1200 may change setting values of the operating parameters based on the third FSP data set DSET3 corresponding to the third FSP operation mode. According to the above description, the memory device 1200 may operate normally even in the operating environment where a temperature is sharply decreased.

Meanwhile, unlike the above description, for example, the SoC 1100 may determine the current FSP operation mode FSP_CUR without consideration of the temperature range of the memory device 1200. Also, unlike the above description, the FSP data DATA_FSP may not include an FSP data set optimized for the memory device 1200 operating in a specific temperature range. In this case, the memory device 1200 may be incapable of operating normally in various temperature ranges. For example, the memory device 1200 may be incapable of operating normally under a temperature condition of −10° C. or lower or a temperature condition of +100° C. or higher.

As described above, according to some embodiments of the present disclosure, the SoC 1100 may train the memory device 1200 for each operating environment based on the training code TCODE. The SoC 1100 may obtain the first to ninth FSP data sets DSET1 to DSET9 through the training. Each of the first to ninth FSP data sets DSET1 to DSET9 may include information about operating parameters for the optimal operation of the memory device 1200 in the corresponding operating environment. After the training, the SoC 1100 may determine the current FSP operation mode FSP_CUR, based on the current operating environment of the memory device 1200. The memory device 1200 may operate based on an FSP data set corresponding to the current FSP operation mode FSP_CUR. Accordingly, the memory device 1200 may operate based on the operating parameters for the optimal operation in the current operating environment. Meanwhile, in the training, operating environments may be finely classified based on the operation frequency and the temperature range of the memory device 1200. Accordingly, the memory device 1200 may operate normally in various temperature ranges (e.g., a temperature range including a temperature condition of −10° C. or lower or a temperature condition of +100° C. or higher) and various operating frequencies.

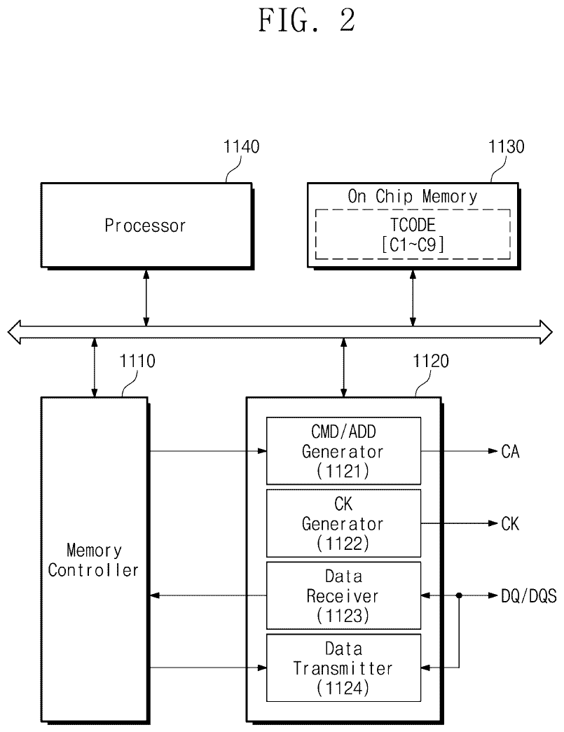

FIG. 2 is a block diagram illustrating an SoC of FIG. 1. Referring to FIGS. 1 and 2, the SoC 1100 may include the memory controller 1110, the PHY 1120, the on chip memory 1130, and a processor 1140.

The memory controller 1110 may communicate with the memory device 1200 through the PHY 1120. The memory controller 1110 may be configured to control the memory device 1200 under control of the processor 1140. Although not illustrated in a drawing, the memory controller 1110 may include various components for controlling the memory device 1200, such as a command queue, a command scheduler, and a data queue.

The PHY 1120 may support a physical layer for the communication between the memory controller 1110 and the memory device 1200. The PHY 1120 may include a command/address generator 1121, a clock generator 1122, a data receiver 1123, and a data transmitter 1124.

The command/address generator 1121 may generate the command/address signal CA to be transmitted to the memory device 1200 under control of the memory controller 1110. The generated command/address signal CA may be provided to the memory device 1200 through command address lines. The clock generator 1122 may generate the clock signal CK to be provided to the memory device 1200. The generated clock signal CK may be provided to the memory device 1200 through the clock line. In some embodiments, the memory device 1200 may operate based on the clock signal CK provided from the SoC 1100.

The data receiver 1123 may receive the data signal DQ and the data strobe signal DQS from the memory device 1200. The data receiver 1123 may be configured to capture the data signals DQ at the rising edge or the falling edge of the data strobe signal DQS. The data transmitter 1124 may output transmission data provided from the memory controller 1110 through the data signal DQ and the data strobe signal DQS.

The on chip memory 1130 may include various components, which are used by the electronic device 1000 to operate, such as an application program, an operating system, a file system, and a device driver. As described with reference to FIG. 1, the on chip memory 1130 may include the training code TCODE for training the memory device 1200.

Unlike the example illustrated in FIGS. 1 and 2, in some embodiments, the training code TCODE may not be included in the on chip memory 1130. In this case, the SoC 1100 may obtain the training code TCODE from an external device (not illustrated).

The processor 1140 may control all the operations of the SoC 1100. The processor 1140 may execute various software (e.g., an application program, an operating system, a file system, and a device driver) stored in or loaded to the on chip memory 1130. The processor 1140 may include homogeneous multi-core processors or heterogeneous multi-core processors. For example, the processor 1140 may include at least one of various information processing devices such as a central processing unit (CPU), an image signal processing unit (ISP), a digital signal processing unit (DSP), a graphics processing unit (GPU), a vision processing unit (VPU), and a neural processing unit (NPU).

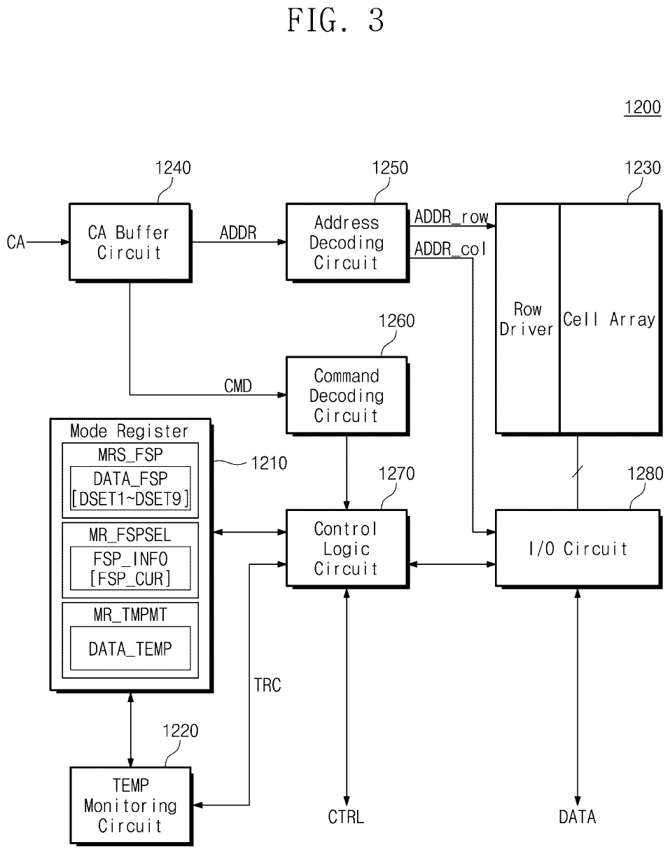

FIG. 3 is a block diagram illustrating a memory device of FIG. 1. Referring to FIGS. 1 to 3, the memory device 1200 may include the mode register 1210, the temperature monitoring circuit 1220, a memory cell array 1230, a CA buffer circuit 1240, an address decoding circuit 1250, a command decoding circuit 1260, a control logic circuit 1270, and an input/output circuit 1280.

The mode register 1210 may include the FSP mode register sets MRS_FSP, the FSP selection mode register MR_FSPSEL, and the temperature monitoring mode register MR_TMPMT. The FSP mode register sets MRS_FSP, the FSP selection mode register MR_FSPSEL, and the temperature monitoring mode register MR_TMPMT are described with reference to FIG. 1, and thus, additional description will be omitted to avoid redundancy.

The temperature monitoring circuit 1220 may determine whether the temperature range of the memory device 1200 is changed, based on temperature data DATA_TEMP stored in the temperature monitoring mode register MR_TMPMT. When the temperature range is changed, the temperature monitoring circuit 1220 may transmit a temperature range change signal TRC to the control logic circuit 1270. The control logic circuit 1270 may update the temperature data DATA_TEMP in response to the temperature range change signal TRC. In some embodiments, the temperature data DATA_TEMP may include information about a current temperature range of the memory device 1200 and information about whether a temperature range is changed. Meanwhile, in some embodiments, the SoC 1100 may check the temperature data DATA_TEMP every specific period. When the temperature range is determined through the temperature data DATA_TEMP as being changed, the SoC 1100 may change the current FSP operation mode FSP_CUR of the memory device 1200 to an FSP operation mode corresponding to the current temperature range.

The memory cell array 1230 may include a plurality of memory cells. The plurality of memory cells may be arranged along a row direction and a column direction. The plurality of memory cells may be connected to a plurality word lines and a plurality of bit lines. In some embodiments, each of the plurality of memory cells may be a dynamic random access memory (DRAM) cell which includes an access transistor and a storage capacitor. In some embodiments, the word lines may be driven by a row driver.

The CA buffer circuit 1240 may receive the command/address CA from the SoC 1100. The CA buffer circuit 1240 may be configured to buffer the received signals.

The address decoding circuit 1250 may receive an address ADDR from the CA buffer circuit 1240 and may decode the received address ADDR. Based on a decoding result, the address decoding circuit 1250 may provide a row address ADDR_row to the row driver and may provide a column address ADDR_col to the input/output circuit 1280.

The command decoding circuit 1260 may receive a command CMD from the CA buffer circuit 1240 and may decode the received command CMD. The command decoding circuit 1260 may provide a decoding result to the control logic circuit 1270.

The control logic circuit 1270 may control all the operations of the memory device 1200 based on the decoding result of the command decoding circuit 1260. In some embodiments, the control logic circuit 1270 may control operating parameters of the memory device 1200 based on the current FSP operation mode FSP_CUR. In detail, the control logic circuit 1270 may determine setting values of the operating parameters based on an FSP operating data set corresponding to the current FSP operation mode FSP_CUR.

The input/output circuit 1280 may be connected to the memory cell array 1230 through the bit lines. The input/output circuit 1280 may control the bit lines based on the column address ADDR_col from the address decoding circuit 1250. In some embodiments, the input/output circuit 1280 may include an input/output sense amplifier (IOSA) used in the read operation of the memory device 1200 and a write driver used in the write operation of the memory device 1200.

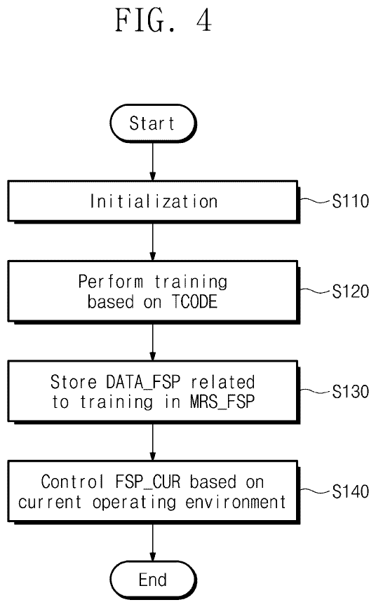

FIG. 4 is a flowchart for describing an operating method of an SoC of FIG. 1. Referring to FIGS. 1 and 4, in operation S110, the SoC 1100 may perform an initialization operation. During the initialization operation, the SoC 1100 may provide a power supply voltage to the memory device 1200 and may perform various initial setting operations, and the SoC 1100 may read necessary information from the memory device 1200 or may set necessary information.

In operation S120, the SoC 1100 may perform training for the memory device 1200 based on the training code TCODE. The SoC 1100 may perform training for the memory device 1200 for each operating environment (e.g., for each operation frequency and temperature range). The training may include operations for obtaining optimal operating parameter values of the memory device 1200. For example, the optimal operating parameter values may mean parameter values which allow the memory device 1200 to operate with the maximum operating margin in a current operating environment. The SoC 1100 may obtain the FSP data DATA_FSP through the training. The FSP data DATA_FSP may include the first to ninth FSP data sets DSET1 to DSET9 corresponding to the first to ninth FSP operation modes. For example, the FSP data DATA_FSP may include information about optimal operating parameter values for each operating environment of the memory device 1200.

Meanwhile, as described with reference to FIG. 1, the training code TCODE may include the first to ninth codes C1 to C9, and the first to ninth codes C1 to C9 may correspond to the first to ninth operating environments. Accordingly, the first to ninth FSP data sets DSET1 to DSET9 may include information operating parameters for the optimal operation of the memory device 1200 in association with the first to ninth operating environments.

In operation S130, the SoC 1100 may store the FSP data DATA_FSP in the FSP mode register sets MRS_FSP.

In operation S140, the SoC 1100 may control the current FSP operation mode FSP_CUR of the memory device 1200, based on the current operating environment of the memory device 1200. In detail, the SoC 1100 may determine the current FSP operation mode FSP_CUR of the memory device 1200, based on the current operating environment of the memory device 1200. In some embodiments, the current operating environment of the memory device 1200 may include a current operation frequency and a current temperature range of the memory device 1200. For example, the current operating environment of the memory device 1200 may be changed. In this case, the SoC 1100 may change the current FSP operation mode FSP_CUR of the memory device 1200 to an FSP operation mode corresponding to the changed operating environment. Meanwhile, the operating parameters of the memory device 1200 may be determined based on an FSP data set corresponding to the current FSP operation mode FSP_CUR.

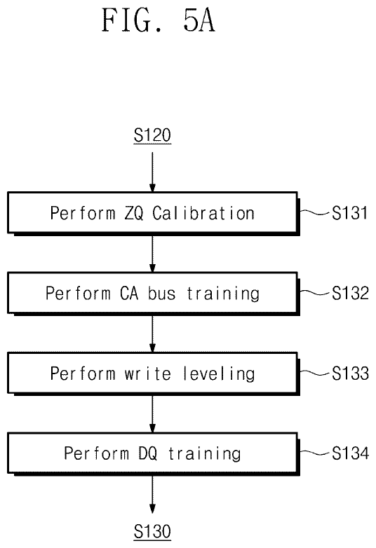

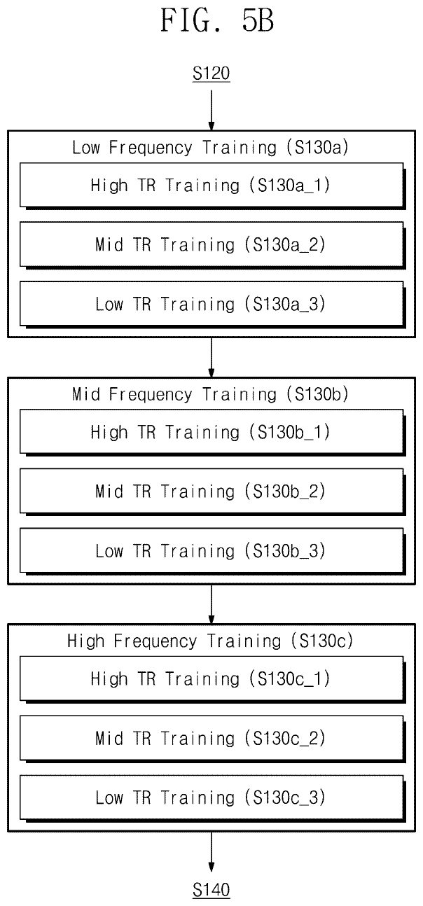

FIGS. 5A and 5B are diagrams for describing a training operation of FIG. 4 in detail. Referring to FIG. 5A, the training may include various operations for obtaining information about operating parameters of the memory device 1200. In operation S131, the SoC 1100 may perform a ZQ calibration operation. For example, the SoC 1100 may perform an operation of adjusting the strength of the data signal DQ or output drivers connected to any other signal lines or an operation of setting an ODT value, such that high data integrity is provided.

In operation S132, the SoC 1100 may perform a CA bus training operation. An internal CA reference voltage VREF_CA may be calibrated through the command/address bus training, and the command/address signal CA may be aligned with the clock signal CK. According to some embodiments of the present disclosure, the SoC 1100 may determine CA reference voltages VREF_CA for respective operating environments (e.g., the first operating environment to the ninth operating environment) through the CA bus training. The determined CA reference voltages VREF_CA may be included in the FSP data DATA_FSP so as to be stored in the mode register 1210.

In operation S133, the SoC 1100 may perform a write leveling operation. The timing or skew of the data strobe signal DQS may be adjusted through the write leveling operation.

In operation S134, the SoC 1100 may perform a DQ training operation. Through the DQ training, an internal DQ reference voltage VREF_DQ, the data signal DQ, and the data strobe signal DQS may be calibrated or trained to be appropriate for each FSP.

The initialization operation or training operation between the SoC 1100 and the memory device 1200 is briefly described with reference to FIGS. 4 and 5A, but the present disclosure is not limited thereto. Detailed operation methods for various operations such as the ZQ calibration operation, the command address (CA) bus training operation, the write leveling operation, and the DQ training operation may be easily understood by one skilled in the art or may correspond to various operations which are supported through various standard interfaces defined by the JEDEC standard such as LPDDR, DDR, and GDDR.

Meanwhile, referring to FIG, 5B, the training may include performing training associated with the low operation frequency (S130a), performing training associated with the middle operation frequency (S130b), and performing training associated with the high operation frequency (S130c).

The performing of the training associated with the low operation frequency (S130a) may include performing training associated with the high temperature range TR (S130a_1), performing training associated with the middle temperature range TR (S130a_2), and performing training associated with the low temperature range TR (S130a_3).

In some embodiments, the SoC 1100 may perform the low operation frequency training based on the first to third codes C1 to C3 (S130a). That is, the SoC 1100 may perform training for the low operation frequency for each temperature range of the memory device 1200. Meanwhile, as described above, the first code C1 to the ninth code C9 may be associated with the operation option of the memory device 1200. For example, when the training is performed based on the first code C1, the memory device 1200 may operate as if operating in the first operating environment (i.e., of the low operation frequency and the high temperature range). For example, when the training is performed based on the second code C2, the memory device 1200 may operate as if operating in the second operating environment (i.e., of the low operation frequency and the middle temperature range). For example, when the training is performed based on the third code C3, the memory device 1200 may operate as if operating in the third operating environment (i.e., of the low operation frequency and the low temperature range).

Meanwhile, the SoC 1100 may obtain the first FSP data set DSET1 by performing the training S130a_1 associated with the low operation frequency and the high temperature range. The first FSP data set DSET1 may include information about operating parameters for the optimal operation of the memory device 1200 in the operating environment (i.e., the first operating environment) of the low operation frequency and the high temperature range. The SoC 1100 may obtain the second FSP data set DSET2 by performing the training S130a_2 associated with the low operation frequency and the middle temperature range. The second FSP data set DSET2 may include information about operating parameters for the optimal operation of the memory device 1200 in the operating environment (i.e., the second operating environment) of the low operation frequency and the middle temperature range. The SoC 1100 may obtain the third FSP data set DSET3 by performing the training S130a_3 associated with the low operation frequency and the low temperature range. The third FSP data set DSET3 may include information about operating parameters for the optimal operation of the memory device 1200 in the operating environment (i.e., the third operating environment) of the low operation frequency and the low temperature range.

The performing of the training associated with the middle operation frequency (S130b) may include performing training associated with the high temperature range TR (S130b_1), performing training associated with the middle temperature range TR (S130b_2), and performing training associated with the low temperature range TR (S130b_3).

In some embodiments, the SoC 1100 may perform the middle operation frequency training based on the fourth to sixth codes C4 to C6 (S130b). For example, when the training is performed based on the fourth code C4, the memory device 1200 may operate as if operating in the fourth operating environment (i.e., of the middle operation frequency and the high temperature range). For example, when the training is performed based on the fifth code C5, the memory device 1200 may operate as if operating in the fifth operating environment (i.e., of the middle operation frequency and the middle temperature range). For example, when the training is performed based on the sixth code C6, the memory device 1200 may operate as if operating in the sixth operating environment (i.e., of the middle operation frequency and the low temperature range).

That is, the SoC 1100 may perform training for the middle operation frequency for each temperature range of the memory device 1200. The SoC 1100 may perform training for the middle operation frequency to obtain the fourth to sixth FSP data sets DSET4 to DSET6. The fourth to sixth FSP data sets DSET4 to DSET6 may include information about operating parameters for the optimal operation of the memory device 1200 in the fourth to sixth operating environments.

The performing of the training associated with the high operation frequency (S130c) may include performing training associated with the high temperature range TR (S130c_1), performing training associated with the middle temperature range TR (S130c_2), and performing training associated with the low temperature range TR (S130c_3).

In some embodiments, the SoC 1100 may perform the high operation frequency training based on the seventh to ninth codes C7 to C9 (S130c). For example, when the training is performed based on the seventh code C7, the memory device 1200 may operate as if operating in the seventh operating environment (i.e., of the high operation frequency and the high temperature range). For example, when the training is performed based on the eighth code C8, the memory device 1200 may operate as if operating in the eighth operating environment (i.e., of the high operation frequency and the middle temperature range). For example, when the training is performed based on the ninth code C9, the memory device 1200 may operate as if operating in the ninth operating environment (i.e., of the high operation frequency and the low temperature range).

That is, the SoC 1100 may perform training for the high operation frequency for each temperature range of the memory device 1200. The SoC 1100 may perform training for the high operation frequency to obtain the seventh to ninth FSP data sets DSET7 to DSET9. The seventh to ninth FSP data sets DSET7 to DSET9 may include information about operating parameters for the optimal operation of the memory device 1200 in the seventh to ninth operating environments.

As described above, the SoC 1100 may train the memory device 1200 for each operation frequency and temperature range. In some embodiments, each of the ZQ calibration operation S131, the CA bus training operation S132, the write leveling operation S133, and the DQ training operation S134 may include training for each operation frequency and temperature range.

For example, the performing of the CA bus training (S132) may include performing training associated with the low operation frequency (S130a), performing training associated with the middle operation frequency (S130b), and performing training associated with the high operation frequency (S130c).

In this case, each of operation S130a to operation S130c in which training associated with operating frequencies is performed may include performing training associated with the high temperature range (e.g., S130a_1), performing training associated with the middle temperature range (e.g., S130a_2), and performing training associated with the low temperature (e.g., S130a_3).

Accordingly, the SoC 1100 may obtain the FSP data DATA_FSP for the optimal operation of the memory device 1200 for each of operating environments (e.g., for each of the first to ninth operating environments). That is, the SoC 1100 may obtain the first to ninth FSP data sets DSET1 to DSET9 corresponding to the operating environments (e.g., the first to ninth operating environments). The SoC 1100 may determine the current FSP operation mode FSP_CUR based on a current operating environment (e.g., a current operation frequency and a current temperature range). Accordingly, the memory device 1200 may operate based on an FSP data set corresponding to the current FSP operation mode FSP_CUR. This may mean that the memory device 1200 is capable of performing the optimal operation in various operating environments.

Meanwhile, in FIG. 5B, for each operating frequency, performing training associated with the high temperature range (e.g., S130a_1, S130b_1, S130c_1), performing training associated with the middle temperature range (e.g., S130a_2, S130b_2, S130c_2), and performing training associated with the low temperature range (e.g., S130a_3, S130b_3, S130c_3) are shown as being performed sequentially, but the present disclosure is not limited thereto. That is, unlike that shown in FIG. 5B, the performance order of performing training associated with the high temperature range (e.g., S130a_1, S130b_1, S130c_1), performing training associated with the middle temperature range (e.g., S130a_2, S130b_2, S130c_2), and performing training associated with the low temperature range (e.g., S130a_3, S130b_3, S130c_3) may be changed. Specifically, for example, in the step of performing training associated with low operation frequency S130a, the step of performing training associated with middle temperature range S130a_2 may be performed before the step of performing training associated with high temperature range S130a_1.

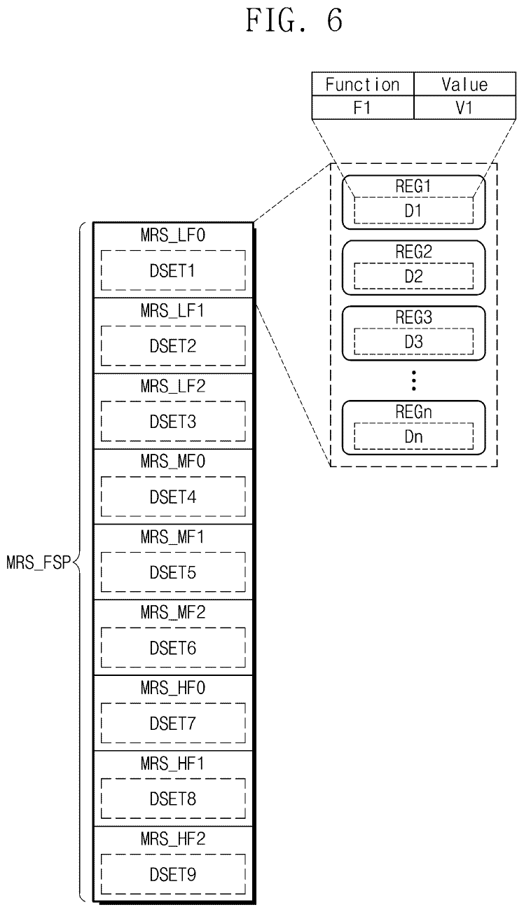

FIG. 6 is a diagram for describing FSP mode register sets of FIG. 1. Referring to FIG. 6, the FSP mode register sets MRS_FSP may include first to ninth mode register sets MRS_LF0 to MRS_HF2. The first to ninth mode register sets MRS_LF0 to MRS_HF2 may respectively store the first to ninth FSP data sets DSET1 to DSET9. For example, the first mode register set MRS_LF0 may store the first FSP data set DSET1, and the second mode register set MRS_LF1 may store the second FSP data set DSET2.

Meanwhile, each of the FSP mode register sets MRS_LF0 to MRS_HF2 may include a plurality of registers. The plurality of registers may store an FSP data set. For example, the first FSP mode register set MRS_LF0 may include a plurality of registers REG1 to REGn. The plurality of registers REG1 to REGn may store data D1 to Dn. In detail, the first register REG1 may store the first data D1, and the n-th register REGn may store the n-th data Dn. The data D1 to Dn may be included in the first FSP data set DSET1. For example, the first data D1 may include information indicating that a value corresponding to a first function F1 of the memory device 1200 is a first value V1.

In some embodiments, the first function F1 may refer to the internal CA reference voltage VREF_CA of the memory device 1200, and the first value V1 may indicate a specific voltage value.

In some embodiments, the first function F1 may be a DQ ODT function, and the first value V1 may indicate that the DQ ODT function is disabled.

Meanwhile, according to some embodiments of the present disclosure, the SoC 1100 may determine the current FSP operation mode FSP_CUR of the memory device 1200 based on a current operating environment. In detail, the SoC 1100 may determine an FSP operation mode corresponding to the current operating environment as the current FSP operation mode FSP_CUR of the memory device 1200. The memory device 1200 may operate based on the FSP data set DSET corresponding to the current FSP operation mode FSP_CUR. That is, the memory device 1200 may determine operating parameters of the memory device 1200 based on the FSP data set DSET corresponding to the current FSP operation mode FSP_CUR.

For example, the first FSP data set DSET1 may store operation data which are applied to the memory device 1200 when the current FSP operation mode FSP_CUR is the first FSP operation mode. Accordingly, when the current FSP operation mode FSP_CUR is the first FSP operation mode, the operating parameters of the memory device 1200 may be determined based on the first FSP data set DSET1. In other words, the first FSP data set DSET1 may be applied to the memory device 1200 which operates in the first operating environment (e.g., of the low operation frequency and the high temperature range).

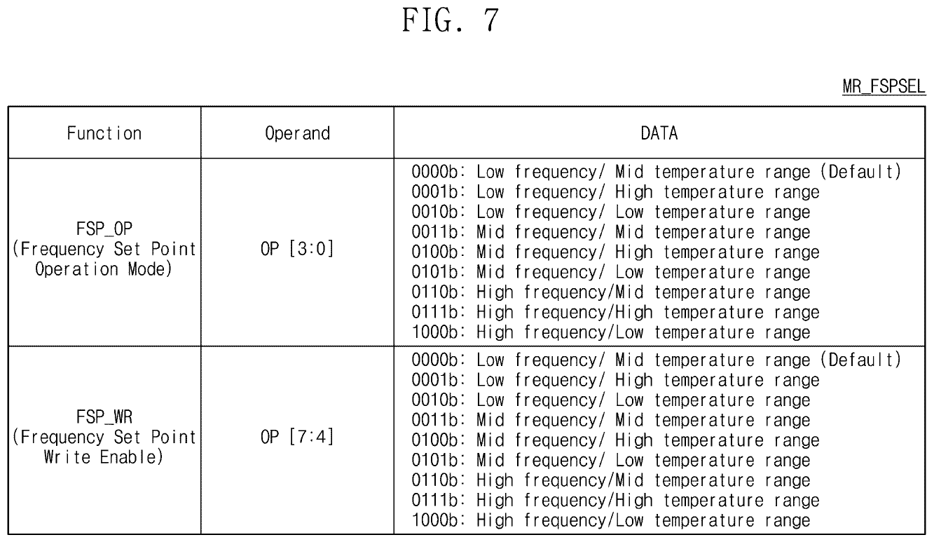

FIG. 7 is a diagram for describing an FSP selection mode register of FIG. 1. Referring to FIG. 7, the FSP selection mode register MR_FSPSEL includes an FSP_OP field and an FSP_WR field. The FSP_OP field may include information about the current FSP operation mode FSP_CUR. That is, the FSP_OP field may include a current operation mode of the memory device 1200. For example, when a setting value of the FSP_OP field is “0010b”, the current FSP operation mode FSP_CUR of the memory device 1200 may be the third FSP operation mode.

The FSP_WR field may include information about a current writable FSP operation mode. For example, the FSP_WR field may indicate that the current writable FSP operation mode is the third FSP operation mode. In this case, the SoC 1100 may transmit a mode register write command to the memory device 1200 to modify or write the third FSP data set DSET3 corresponding to the third FSP operation mode. For example, when a current setting value of the FSP_WR field is “0010b”, the SoC 1100 may manage the third FSP data set DSET3 corresponding to the third FSP operation mode.

Meanwhile, a default of each of the FSP_OP field and the FSP_WR field may be set to correspond to the second FSP operation mode (i.e., an operation environment with low operation frequency and middle temperature range). In some embodiments, before the training (e.g., S120 of FIG. 4) is performed, each of the FSP_OP field and the FSP_WR field may be in a state of being set to correspond to the second FSP operation mode. FIG. 7 shows a configuration of the FSP selection mode register MR_FSPSEL as an example, but the present disclosure is not limited thereto.

In some embodiments, the FSP selection mode register MR_FSPSEL may be a register included in the mode register 1210.

In some embodiments, the setting value of each of the FSP_OP field and the FSP_WR field may be included in the current FSP information FSP_INFO.

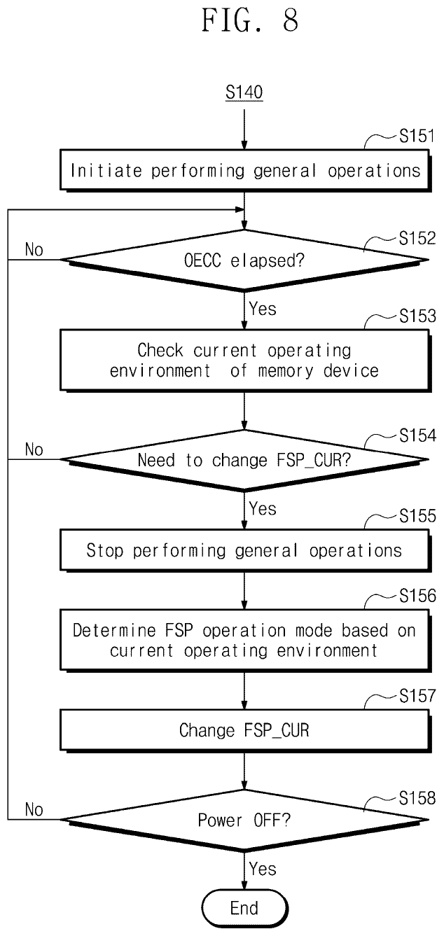

FIG. 8 is a flowchart for describing an operation of controlling a current FSP operation mode, which is described with reference to FIG. 4. Referring to FIG. 8, in operation S151, the SoC 1100 may initiate performing general operations. For example, the general operations may include the read operation, the write operation, etc. of the memory device 1200.

In some embodiments, in operation S151, the FSP of the memory device 1200 may be the seventh FSP. That is, after the training, the setting value of the FSP operation mode of the memory device 1200 may indicate the seventh FSP operation mode. Accordingly, after the training, the memory device 1200 may operate based on the seventh FSP data set DSET7.

In operation S152, the SoC 1100 may determine whether an operating environment check cycle OECC elapses. For example, when the operating environment check cycle OECC elapses, the SoC 1100 may perform operation S153. In contrast, when the operating environment check cycle OECC does not elapse from a point in time when operation S140 of FIG. 4 is terminated, the SoC 1100 may wait until the operating environment check cycle OECC elapses.

In some embodiments, when a current time point is a point in time when the operating environment check cycle OECC elapses from a point in time when operation S140 of FIG. 4 is terminated, the SoC 1100 may determine that the operating environment check cycle OECC elapses. In some embodiments, when a current time point is a point in time when the operating environment check cycle OECC elapses from a point in time when the operating environment of the memory device 1200 is checked, the SoC 1100 may determine that the operating environment check cycle OECC elapses.

In operation S153, the SoC 1100 may check a current operating environment of the memory device 1200. For example, the SoC 1100 may check a current operation frequency of the memory device 1200 and a current temperature range of the memory device 1200.

In operation S154, the SoC 1100 may determine whether to change the current FSP operation mode FSP_CUR. The SoC 1100 may determine whether to change the current FSP operation mode FSP_CUR based on whether the operating environment of the memory device 1200 is changed. When there is a need to change the current FSP operation mode FSP_CUR, the SoC 1100 may perform operation S155. When there is no need to change the current FSP operation mode FSP_CUR, the SoC 1100 may return to operation S152.

In operation S155, the SoC 1100 may stop performing the normal (i.e., general) operations.

In operation S156, the SoC 1100 may determine an FSP operation mode to be changed, based on the current operating environment. The current operating environment may indicate a current operation frequency and a current temperature range of the memory device 1200.

In operation S157, the SoC 1100 may change the current FSP operation mode FSP_CUR of the memory device 1200. In detail, the SoC 1100 may transmit the mode register write command to the memory device 1200. The SoC 1100 may change a setting value (e.g., the FSP_OP field of FIG. 7) of the FSP selection mode register MR_FSPSEL through the mode register write command. Accordingly, the current FSP operation mode FSP_CUR of the memory device 1200 may be changed. Meanwhile, as the current FSP operation mode FSP_CUR of the memory device 1200 is changed, operating parameters of the memory device 1200 may be changed based on an FSP data set corresponding to the current FSP operation mode thus changed.

In operation S158, the SoC 1100 may determine whether the electronic device 1000 is in a power-off state. When the electronic device 1000 is not in the power-off state, the SoC 1100 may return to operation S152.

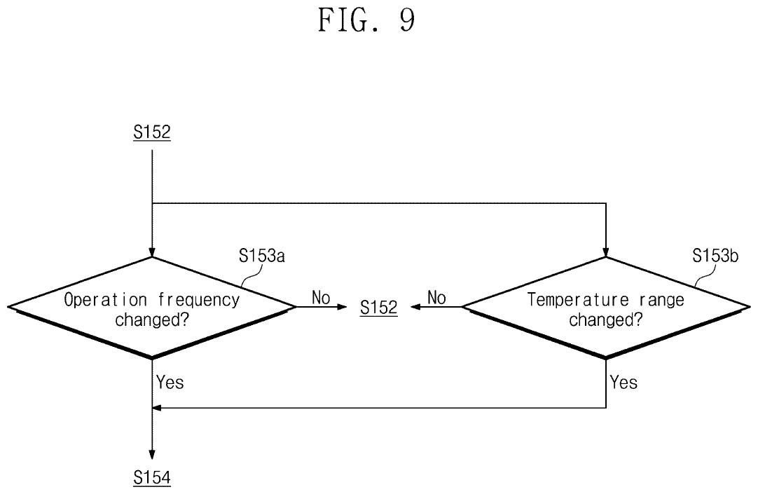

FIG. 9 is a flowchart for describing an operation of determining whether to change a current FSP operation mode, which is described with reference to FIG. 8. Referring to FIG. 9, in operation S153a, the SoC 1100 may determine whether an operation frequency is changed. For example, the SoC 1100 may determine whether the operation frequency is changed, in consideration of whether the transmission of the command/address signal CA and the data “DATA” is normally performed. When the operation frequency is changed, the SoC 1100 may perform operation S154. When the operation frequency is not changed, the SoC 1100 may perform operation S152.

In operation S153b, the SoC 1100 may determine whether the temperature range of the memory device 1200 is changed. For example, the SoC 1100 may determine whether the temperature range of the memory device 1200 is changed, based on the temperature data DATA_TEMP stored in the temperature monitoring mode register MR_TMPMT. When the temperature range is changed, the SoC 1100 may perform operation S154. When the temperature range is not changed, the SoC 1100 may perform operation S152.

According to some embodiments of the present disclosure, when the operation frequency or the temperature range of the memory device 1200 is changed, the SoC 1100 may change the FSP operation mode of the memory device 1200. Accordingly, the memory device 1200 may operate based on the operating parameters optimized for the current operating environment. This may mean that the memory device 1200 is capable of normally operating in various operating environments.

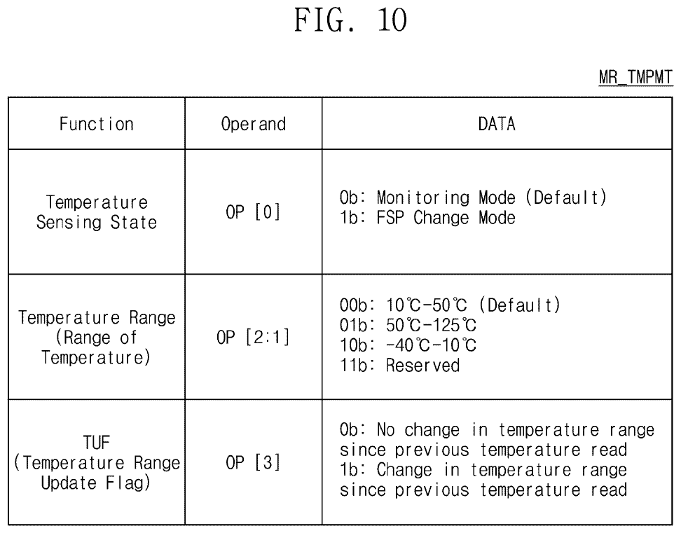

FIG. 10 is a diagram for describing the temperature monitoring mode register MR_TMPMT of FIG. 1. Referring to FIG. 10, the temperature monitoring mode register MR_TMPMT may include a “temperature sensing state” field, a “temperature range” field, and a “temperature range update flag (TUF)” field. As used herein, the “temperature range update flag (TUF)” field may also be referred to as a “temperature range change flag” field. In some embodiments, the temperature data DATA_TEMP of FIG. 1 may include setting values of the “temperature sensing state” field, the “temperature range” field, and the “TUF” field.

The “temperature sensing state” field refers to a field indicating whether the memory device 1200 currently operates for general operations (e.g., a read operation and a write operation) or operates for the change in the FSP operation mode. When the setting value of the “temperature sensing state” field is “0b”, the memory device 1200 may operate for general operations (e.g., a read operation and a write operation). When the setting value of the “temperature sensing state” field is “1b”, the memory device 1200 may operate for the change in the FSP operation mode.

The “temperature range” field refers to a field indicating a current temperature range of the memory device 1200. When the setting value of the “temperature range” field is “00b”, the current temperature range may be the middle temperature range. When the setting value of the “temperature range” field is “01b”, the current temperature range may be the high temperature range. When the setting value of the “temperature range” field is “10b”, the current temperature range may be the low temperature range.

The “TUF” field refers to a field indicating whether the change in the current temperature range is made. The case where the setting value of the “TUF” field is “0b” may indicate that the current temperature range is not changed. The case where the setting value of the “TUF” field is “1b” may indicate that the current temperature range is changed. The SoC 1100 may check the “TUF” field to determine whether the current temperature range of the memory device 1200 is changed. When the current temperature range is changed, the SoC 1100 may change the FSP operation mode of the memory device 1200.

In some embodiments, the temperature monitoring mode register MR_TMPMT may be implemented by using at least one of the registers included in the mode register 1210.

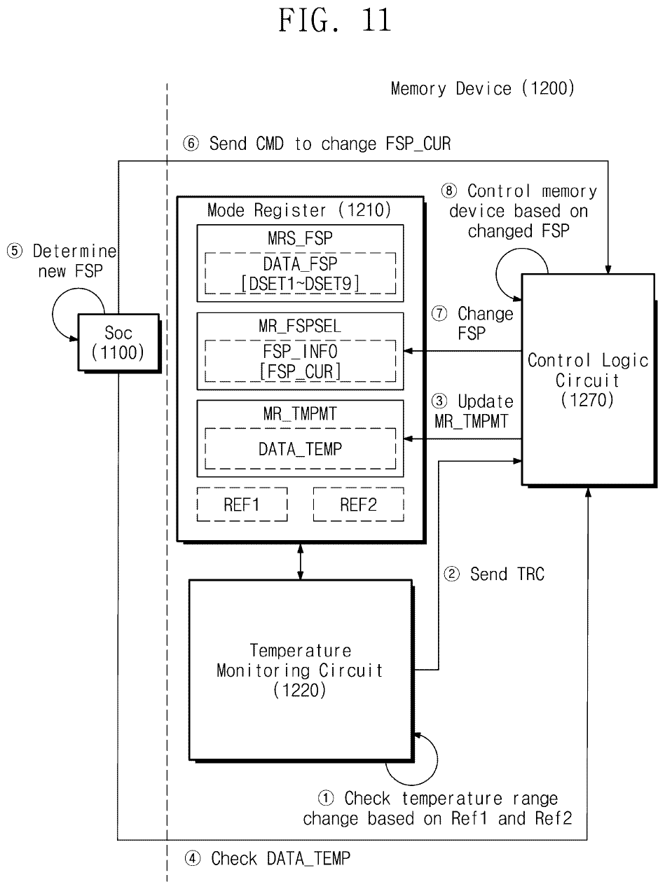

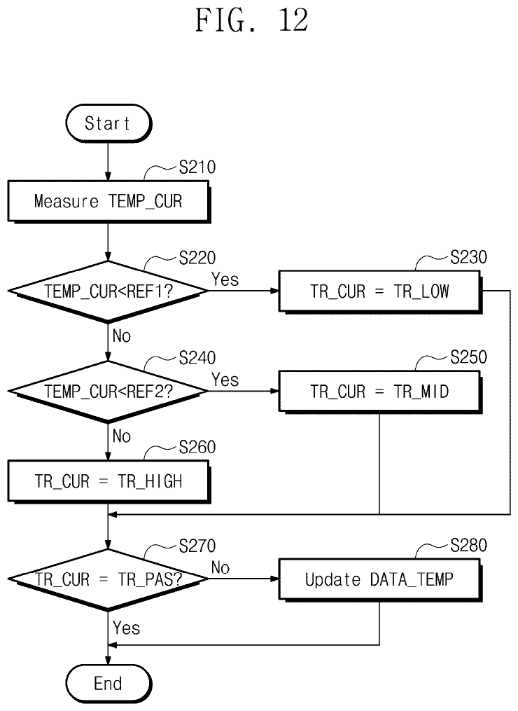

FIG. 11 is a diagram for describing an operation of an electronic device of FIG. 1 in detail. In detail, FIG. 11 is a diagram for describing an FSP operation mode managing method of the electronic device 1000 after the training is completed. FIG. 11 will be described with reference to FIGS. 1 to 10. Referring to FIG. 11, in a first operation \textcircled{1}, the temperature monitoring circuit 1220 may determine that the change in the temperature range is made. In detail, the temperature monitoring circuit 1220 may measure a current temperature. The temperature monitoring circuit 1220 may compare the current temperature with reference values REF1 and REF2 to check the current temperature range. In some embodiments, the reference values REF1 and REF2 may be stored in advance in the mode register 1210. In some embodiments, the first reference value REF1 may be 10° C. In some embodiments, the second reference value REF2 may be 50° C. The temperature monitoring circuit 1220 may compare the current temperature range with a past temperature range. When there is a difference in a comparison result, the temperature monitoring circuit 1220 may determine that there is the change in the temperature range. An operation of the temperature monitoring circuit 1220 will be described in detail with reference to FIG. 12.

In a second operation \textcircled{2}, the temperature monitoring circuit 1220 may transmit the temperature range change signal TRC to the control logic circuit 1270. In some embodiments, the temperature range change signal TRC may include information about the current temperature range and information indicating the change in the temperature range.

In a third operation \textcircled{3}, the control logic circuit 1270 may update the temperature monitoring mode register MR_TMPMT. That is, the control logic circuit 1270 may update the temperature data DATA_TEMP. In detail, the control logic circuit 1270 may change the setting value of the “temperature sensing state” field of the temperature monitoring mode register MR_TMPMT to “1b”. Also, the control logic circuit 1270 may change the setting value of the “temperature range” field of the temperature monitoring mode register MR_TMPMT to correspond to the current temperature range. Also, the control logic circuit 1270 may display that there is the change in the temperature range, by changing the setting value of the “TUF” field of the temperature monitoring mode register MR_TMPMT to “1b”.

In a fourth operation \textcircled{4}, the SoC 1100 may check the temperature data DATA_TEMP. In detail, after the operating environment check cycle OECC elapses, the SoC 1100 may transmit a mode register read command for the temperature monitoring mode register MR_TMPMT to the memory device 1200. Accordingly, the SoC 1100 may check the temperature data DATA_TEMP. Meanwhile, the SoC 1100 may determine that the temperature range is changed, through the temperature data DATA_TEMP. Also, the SoC 1100 may check a current temperature range of the memory device 1200 through the temperature data DATA_TEMP.

In a fifth operation \textcircled{5}, the SoC 1100 may determine a new FSP operation mode. In detail, the SoC 1100 may determine a new FSP operation mode based on a current temperature range and a current operation frequency of the memory device 1200.

In a sixth operation \textcircled{6}, the SoC 1100 may transmit a command for the change in the FSP operation mode. In detail, the SoC 1100 may transmit the mode register write command directing the change of the current FSP operation mode FSP_CUR to the new FSP operation mode.

In a seventh operation \textcircled{7}, the control logic circuit 1270 may change the current FSP operation mode FSP_CUR in response to the mode register write command from the SoC 1100. In detail, the control logic circuit 1270 may change the current FSP operation mode FSP_CUR by changing the FSP information FSP_INFO of the FSP selection mode register MR_FSPSEL. The control logic circuit 1270 may change the FSP_OP field of the FSP selection mode register MR_FSPSEL to correspond to the current FSP operation mode FSP_CUR. Accordingly, the current FSP operation mode FSP_CUR may be changed.

In an eighth operation \textcircled{8}, the control logic circuit 1270 may control the memory device 1200 based on the changed current FSP operation mode FSP_CUR. In detail, the control logic circuit 1270 may control the memory device 1200 based on an FSP data set corresponding to the changed current FSP operation mode FSP_CUR. That is, the control logic circuit 1270 may change operating parameters of the memory device 1200 based on the FSP data set corresponding to the changed current FSP operation mode FSP_CUR. Accordingly, the memory device 1200 may perform an operation normally with an optimal operating margin in the current operating environment.

FIG. 12 is a diagram for describing an operating method of a memory device of FIG. 1. In detail, FIG. 12 is a diagram for describing how the memory device 1200 manages the temperature data DATA_TEMP. FIG. 12 will be described with reference to FIGS. 1 to 11. Referring to FIG. 12, in operation S210, the memory device 1200 may measure a current temperature TEMP_CUR.

In operation S220, the memory device 1200 may determine whether the current temperature TEMP_CUR is lower than the first reference value REF1. The first reference value REF1 may be a value stored in the mode register 1210. For example, the first reference value REF1 may be 10° C. When the current temperature TEMP_CUR is lower than the first reference value REF1, the memory device 1200 may perform operation S230. When the current temperature TEMP_CUR is higher than the first reference value REF1, the memory device 1200 may perform operation S240.

In operation S230, the memory device 1200 may determine that a current temperature range TR_CUR is a low temperature range TR_LOW.

In operation S240, the memory device 1200 may determine whether the current temperature TEMP_CUR is lower than the second reference value REF2. The second reference value REF2 may be a value stored in the mode register 1210. For example, the second reference value REF2 may be 50° C. When the current temperature TEMP_CUR is lower than the second reference value REF2, the memory device 1200 may perform operation S250. When the current temperature TEMP_CUR is higher than the second reference value REF2, the memory device 1200 may perform operation S260.

In operation S250, the memory device 1200 may determine that the current temperature range TR_CUR is a middle temperature range TR_MID. In operation S260, the memory device 1200 may determine that the current temperature range TR_CUR is a high temperature range TR_HIGH.

In operation S270, the memory device 1200 may determine whether the current temperature range TR_CUR is identical to (i.e., the same as) a past temperature range TR_PAS. That is, the memory device 1200 may determine whether the current temperature range TR_CUR is changed. For example, the past temperature range TR_PAS may be checked through the temperature data DATA_TEMP. For example, the memory device 1200 may check the past temperature range TR_PAS through the setting value of the “temperature range” field of the temperature monitoring mode register MR_TMPMT of FIG. 10. When the current temperature range TR_CUR is different from the past temperature range TR_PAS, the memory device 1200 may perform operation S280.

In some embodiments, operation S210 to operation S270 may be performed by the temperature monitoring circuit 1220.

In operation S280, the memory device 1200 may update the temperature data DATA_TEMP. For example, the temperature monitoring circuit 1220 may transmit the temperature range change signal TRC to the control logic circuit 1270. The control logic circuit 1270 may update the temperature data DATA_TEMP in response to the temperature range change signal TRC. For example, the control logic circuit 1270 may change the setting value of the “temperature range” field of the temperature monitoring mode register MR_TMPMT to correspond to the current temperature range TR_CUR. Also, the control logic circuit 1270 may display that there is the change in the temperature range, by changing the setting value of the “TUF” field of the temperature monitoring mode register MR_TMPMT to “1b”.

As described above, the memory device 1200 may monitor a temperature change in real time. When the memory device 1200 detects the temperature change, the memory device 1200 may notify the SoC 1100 of the temperature change through the temperature data DATA_TEMP. The SoC 1100 may check the temperature change through the temperature data DATA_TEMP and may change the current FSP operation mode FSP_CUR of the memory device 1200. Accordingly, even though the operating environment is changed, the memory device 1200 may operate normally.

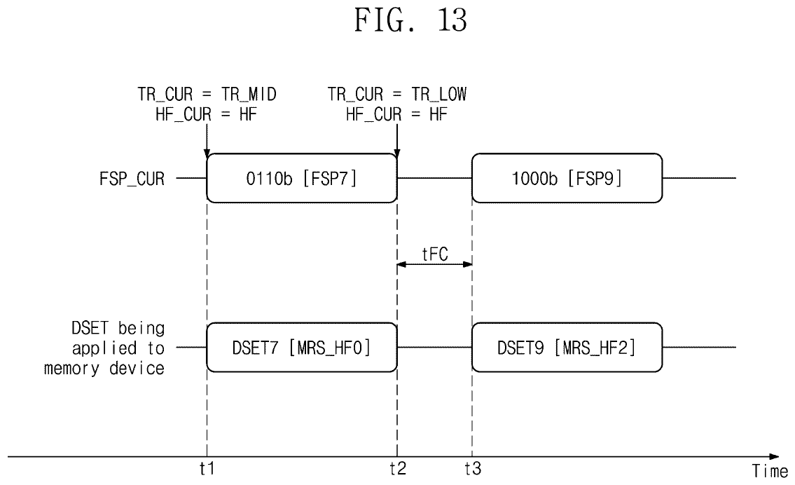

FIG. 13 is a diagram for describing an example of an operation of an electronic device of FIG. 1. FIG. 13 will be described with reference to FIGS. 1 to 12. In FIG. 13, the horizontal axis represents a time. Referring to FIG. 13, at a first point in time t1, the current temperature range TR_CUR of the memory device 1200 may be the middle temperature range TR_MID, and the operation frequency of the memory device 1200 may be the high operation frequency (e.g., HF_CUR=HF). In this case, the setting value of the “FSP_OP” field of the FSP selection mode register MR_FSPSEL of the memory device 1200 may be “0110b”. Accordingly, the current FSP operation mode FSP_CUR of the memory device 1200 may be the seventh FSP operation mode FSP7. Accordingly, the seventh FSP data set DSET7 may be applied to the memory device 1200. That is, the operating parameter of the memory device 1200 may be determined based on the seventh FSP data set DSET7.

After the first point in time t1, at a second point in time t2, the current temperature range TR_CUR of the memory device 1200 may be changed to the low temperature range TR_LOW. In this case, during an FSP operation mode change time tFC, the SoC 1100 may change the setting value of the FSP selection mode register MR_FSPSEL to “1000b”. Accordingly, at a third point in time t3, the FSP operation mode of the memory device 1200 may be the ninth FSP operation mode FSP9. Also, at the third point in time t3, the ninth FSP data set DSET9 may be applied to the memory device 1200. That is, the operating parameter of the memory device 1200 may be determined based on the ninth FSP data set DSET9.

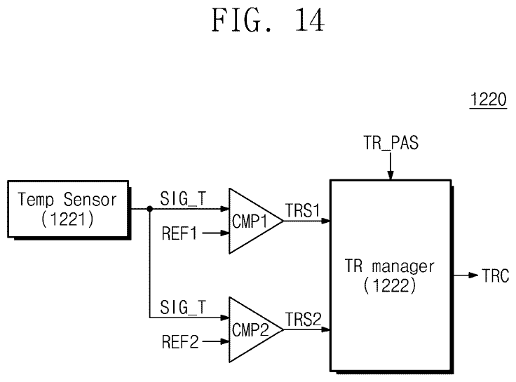

FIG. 14 is a diagram for describing the temperature monitoring circuit 1220 of FIG. 1. Referring to FIG. 14, the temperature monitoring circuit 1220 may include a temperature sensor 1221, a first comparator CMP1, a second comparator CMP2, and a temperature range manager 1222. FIG. 14 shows an example of the temperature monitoring circuit 1220, but the present disclosure is not limited thereto. For example, the temperature monitoring circuit 1220 may be implemented in various methods.

The temperature sensor 1221 may measure a current temperature of the memory device 1200 to generate a temperature signal SIG_T. That is, the temperature signal SIG_T may include information about the current temperature of the memory device 1200.

The first comparator CMP1 may compare the temperature signal SIG_T with the first reference value REF1. The first reference value REF1 may be a value stored in the mode register 1210. The first comparator CMP1 may generate a first temperature range signal TRS1 based on a comparison result. For example, when the temperature signal SIG_T is greater than the first reference value REF1, the first comparator CMP1 may generate the first temperature range signal TRS1 of logic high. For example, when the temperature signal SIG_T is smaller than the first reference value REF1, the first comparator CMP1 may generate the first temperature range signal TRS1 of logic low.

The second comparator CMP2 may compare the temperature signal SIG_T with the second reference value REF2. The second reference value REF2 may be a value stored in the mode register 1210. The second comparator CMP2 may generate a second temperature range signal TRS2 based on a comparison result. For example, when the temperature signal SIG_T is greater than the second reference value REF2, the second comparator CMP2 may generate the second temperature range signal TRS2 of logic high. For example, when the temperature signal SIG_T is smaller than the second reference value REF2, the second comparator CMP2 may generate the second temperature range signal TRS2 of logic low.

The temperature range manager 1222 may determine the current temperature range TR_CUR based on voltage levels of the first temperature range signal TRS1 and the second temperature range signal TRS2. The temperature range manager 1222 may compare the current temperature range TR_CUR with the past temperature range TR_PAS. When the current temperature range TR_CUR is different from the past temperature range TR_PAS, the temperature range manager 1222 may transmit the temperature range change signal TRC to the control logic circuit 1270. Meanwhile, the temperature range manager 1222 may check the past temperature range TR_PAS through the temperature data DATA_TEMP of the temperature monitoring mode register MR_TMPMT.

For example, the temperature range manager 1222 may determine a temperature range corresponding to a current setting value of the “temperature range” field of the temperature monitoring mode register MR_TMPMT as the past temperature range TR_PAS.

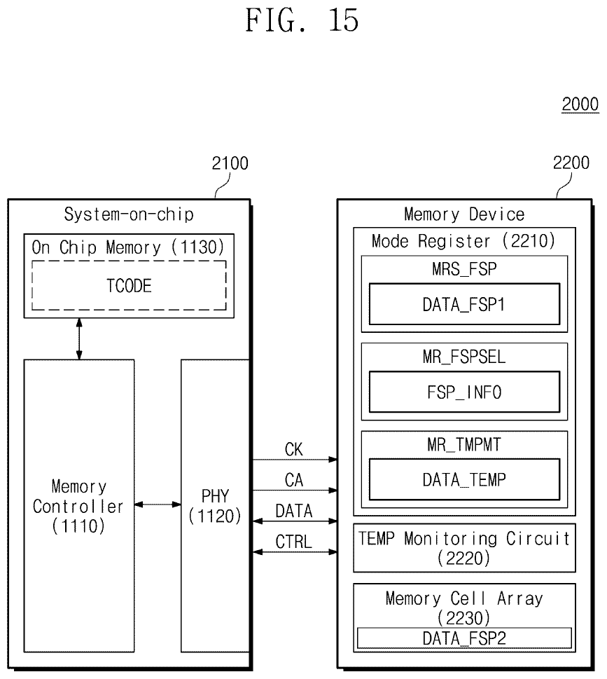

FIG. 15 is a diagram for describing another example of an electronic device according to embodiments of the present disclosure. Referring to FIG. 15, an electronic device 2000 may include an SoC 2100 and a memory device 2200. The electronic device 2000 of FIG. 15 may correspond to the electronic device 1000 of FIG. 1. The SoC 2100 of FIG. 15 may correspond to the SoC 1100 of FIG. 1, and the memory device 2200 of FIG. 15 may correspond to the memory device 1200 of FIG. 1. Accordingly, below, a difference between FIGS. 1 and 15 will be mainly described to avoid repeated descriptions.

Referring to FIG. 15, the first FSP data DATA_FSP1 may be stored in the FSP mode register sets MRS_FSP, and the second FSP data DATA_FSP2 may be stored in a memory cell array 2230. In some embodiments, the first FSP data DATA_FSP1 may include FSP data sets (e.g., the second FSP data set DSET2, the fifth FSP data set DSET5, and the eighth FSP data set DSET8 of FIG. 6) corresponding to the middle temperature range. The second FSP data DATA_FSP2 may include FSP data sets corresponding to the low temperature range and the high temperature range.

That is, unlike the case of FIG. 1, according to the embodiment of FIG. 15, FSP data sets corresponding to the low temperature range and the high temperature range from among FSP data sets (e.g., DSET1, DSET3, DSET4, DSET6, DSET7, and DSET9 of FIG. 6) obtained as a training result may be stored in the memory cell array 2230, not the mode register 1210. Accordingly, the electronic device 2000 according to the embodiment of FIG. 15 may secure a larger free storage space in a mode register 2210, compared to the electronic device 1000 of FIG. 1.

According to the present disclosure, a system-on-chip (SoC) may train a memory device based on a training code. The system-on-chip may obtain frequency set point (FSP) data through the training. The FSP data may include information about operating parameters for the optimal operation of the memory device for each operation frequency and temperature range. After the training, the memory device may operate normally for various operation frequencies and various temperature ranges, based on the FSP data. Accordingly, a memory device with improved reliability and improved performance, a system-on-chip configured to control the memory device, and an electronic device including the same may be provided.

While the present disclosure has been described with reference to example embodiments thereof, it will be apparent to those of ordinary skill in the art that various changes and modifications may be made thereto without departing from the scope of the present disclosure as set forth in the following claims.

As used herein, the terms “comprises”, “comprising”, “includes”, “including”, “has”, “having” and any other variations thereof specify the presence of the stated features, steps, operations, elements, components, and/or groups but do not preclude the presence or addition of one or more other features, steps, operations, elements, components, and/or groups thereof. In addition, it will be understood that, although the terms “first”, “second”, “third”, etc. may be used herein to describe various elements, these elements should not be limited by these terms. Rather, these terms are only used to distinguish one element from another. For example, a first element could be termed a second element, and, similarly, a second element could be termed a first element, without departing from the scope of the present disclosure.

What is claimed is:

1. An electronic device comprising:
a memory device configured to operate in a current frequency set point (FSP) operation mode among a plurality of FSP operation modes; and
a system-on-chip (SoC) configured to control the memory device,
wherein the memory device includes:
FSP mode register sets configured to store a plurality of FSP data sets respectively corresponding to the plurality of FSP operation modes; and
a temperature monitoring circuit configured to monitor a temperature range of the memory device,
wherein the SoC is further configured to control the current FSP operation mode based on a current operation frequency of the memory device and a current temperature range of the memory device, and
wherein the plurality of FSP operation modes include a first FSP operation mode for an operation of the memory device at a first operation frequency and a first temperature range, and a second FSP operation mode for an operation of the memory device at the first operation frequency and a second temperature range higher than the first temperature range.

2. The electronic device of claim 1, wherein each of the FSP data sets includes information about operating parameters of the memory device in a respective one of the FSP operation modes, and
wherein the memory device further includes:
a control logic circuit configured to control the operating parameters of the memory device based on a current FSP data set corresponding to the current FSP operation mode from among the FSP data sets.

3. The electronic device of claim 1, wherein the FSP mode register sets include:
a first FSP mode register set in which a first FSP data set corresponding to the first FSP operation mode from among the FSP data sets is stored; and
a second FSP mode register set in which a second FSP data set corresponding to the second FSP operation mode from among the FSP data sets is stored.

4. The electronic device of claim 3, wherein, before a first time point, the current operation frequency of the memory device is the first operation frequency, and the current temperature range of the memory device is the first temperature range,
wherein, at the first time point, the current temperature range of the memory device is changed to the second temperature range, and
wherein, after the first time point, the SoC is configured to change the current FSP operation mode of the memory device from the first FSP operation mode to the second FSP operation mode.

5. The electronic device of claim 4, wherein the memory device is configured to:
operate based on the first FSP data set, before the first time point; and
operate based on the second FSP data set, at a second time point after the first time point.

6. The electronic device of claim 1, wherein the plurality of FSP operation modes further include:
a third FSP operation mode for an operation of the memory device at the first operation frequency and a third temperature range;
a fourth FSP operation mode for an operation of the memory device at a second operation frequency and the first temperature range;
a fifth FSP operation mode for an operation of the memory device at the second operation frequency and the second temperature range;
a sixth FSP operation mode for an operation of the memory device at the second operation frequency and the third temperature range;
a seventh FSP operation mode for an operation of the memory device at a third operation frequency and the first temperature range;
an eighth FSP operation mode for an operation of the memory device at the third operation frequency and the second temperature range; and
a ninth FSP operation mode for an operation of the memory device at the third operation frequency and the third temperature range.

7. The electronic device of claim 6, wherein the memory device further includes:
an FSP selection mode register configured to store information about the current FSP operation mode.

8. The electronic device of claim 7, wherein the SoC is further configured to:
change the current FSP operation mode by changing a setting value of the FSP selection mode register in response to at least one of the current operation frequency or the current temperature range of the memory device being changed.

9. The electronic device of claim 1, wherein the SoC is further configured to:
obtain the FSP data sets by performing training for the memory device based on a training code; and
store the FSP data sets that were obtained in the FSP mode register sets.

10. The electronic device of claim 9, wherein the training code includes:
a first code for obtaining a first FSP data set corresponding to the first FSP operation mode from among the plurality of FSP data sets; and
a second code for obtaining a second FSP data set corresponding to the second FSP operation mode from among the plurality of FSP data sets.

11. The electronic device of claim 9, wherein the training includes a ZQ calibration operation, a command/address bus training operation, a write leveling operation, and a DQ training operation, which are associated with the memory device.

12. The electronic device of claim 1, wherein the memory device further includes a temperature monitoring mode register configured to store temperature data, and
wherein the temperature data includes information about the current temperature range of the memory device and information about whether the current temperature range is changed.

13. An operating method of a system-on-chip (SoC) configured to control a memory device operating based on a current frequency set point (FSP) operation mode among a plurality of FSP operation modes, the method comprising:
training the memory device for a plurality of operation frequencies and a plurality of temperature ranges, based on a training code;
storing a plurality of FSP data sets, which are obtained through the training and respectively correspond to the plurality of FSP operation modes, in the memory device; and
controlling the current FSP operation mode based on a current operation frequency or a current temperature range of the memory device,
wherein the plurality of FSP operation modes include:
a first FSP operation mode for an operation of the memory device at a first operation frequency among the plurality of operation frequencies and a first temperature range among the plurality of temperature ranges; and
a second FSP operation mode for an operation of the memory device at the first operation frequency and a second temperature range higher than the first temperature range among the plurality of temperature ranges.

14. The method of claim 13, wherein the training code includes:
a first code for obtaining a first FSP data set corresponding to the first FSP operation mode from among the plurality of FSP data sets; and
a second code for obtaining a second FSP data set corresponding to the second FSP operation mode from among the plurality of FSP data sets.

15. The method of claim 13, wherein current operating parameters of the memory device are determined based on a current FSP data set corresponding to the current FSP operation mode from among the FSP data sets.

16. The method of claim 13, wherein the controlling of the current FSP operation mode of the memory device includes:
changing the current FSP operation mode from the first FSP operation mode to the second FSP operation mode in response to the current temperature range of the memory device being changed from the first temperature range to the second temperature range in a state where the current operation frequency of the memory device is the first operation frequency.

17. The method of claim 13, wherein the plurality of FSP operation modes further include:
a third FSP operation mode for an operation of the memory device at the first operation frequency and a third temperature range among the plurality of temperature ranges;
a fourth FSP operation mode for an operation of the memory device at a second operation frequency among the plurality of operation frequencies and the first temperature range;
a fifth FSP operation mode for an operation of the memory device at the second operation frequency and the second temperature range;
a sixth FSP operation mode for an operation of the memory device at the second operation frequency and the third temperature range;
a seventh FSP operation mode for an operation of the memory device at a third operation frequency among the plurality of operation frequencies and the first temperature range;
an eighth FSP operation mode for an operation of the memory device at the third operation frequency and the second temperature range; and
a ninth FSP operation mode for an operation of the memory device at the third operation frequency and the third temperature range.

18. The method of claim 17, wherein the first temperature range indicates a temperature range from −40° C. to +10° C.,
wherein the second temperature range indicates a temperature range from +10° C. to +50° C., and
wherein the third temperature range indicates a temperature range from +50° C. to +125° C.

19. A memory device that is configured to operate based on a current frequency set point (FSP) operation mode among a plurality of FSP operation modes, the memory device comprising:
an FSP selection mode register configured to store information about the current FSP operation mode;
FSP mode register sets configured to store FSP data sets respectively corresponding to the plurality of FSP operation modes;
a temperature monitoring mode register configured to store temperature data associated with a current temperature range of the memory device;
a temperature monitoring circuit configured to monitor the current temperature range; and
a control logic circuit configured to control operating parameters of the memory device based on an FSP data set corresponding to the current FSP operation mode from among the FSP data sets,
wherein the plurality of FSP operation modes include a first FSP operation mode for an operation of the memory device in a first temperature range, and a second FSP operation mode for an operation of the memory device in a second temperature range higher than the first temperature range, and
wherein the current FSP operation mode is determined based on the temperature data.

20. The memory device of claim 19, wherein the plurality of FSP operation modes further include a third FSP operation mode for an operation of the memory device in a third temperature range higher than the second temperature range, and
wherein the first temperature range indicates a temperature range from −40° C. to +10° C., the second temperature range indicates a temperature range from +10° C. to +50° C., and the third temperature range indicates a temperature range from +50° C. to +125° C.
